(19) United States
(12) Patent Application Publication
(10) Pub. No.: US 2006/0171369 A1
(43) Pub. Date: Aug. 3, 2006

(54) Resource utilization for multimedia broadcast multicast services (MBMS)

(75) Inventors: Peter Ostrup, Linkoping (SE); Jens Bergqvist, Linkoping (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET L M ERICSSON (Publ), Stockholm (SE)

(21) Appl. No.: 11/049,283

(22) Filed: Feb. 3, 2005

(51) Int. Cl. H04J 3/24; H04L 12/56

(52) U.S. Cl. 370/349; 370/390

(57) ABSTRACT

A multimedia broadcast multicast type service (MBMS) is offered to mobile subscribers. A RAN node communicates with one or more radio base stations that transmit and receive information with mobile subscriber terminals, some of which subscribe to the MBMS. The RAN node communicates with multiple core network packet data nodes that receive MBMS data for delivery to the RAN node. One of the multiple core network packet data nodes is selected to provide the MBMS data associated with the MBMS to the RAN node. The others are instructed not to provide the MBMS data, but they still perform other MBMS support functions for their mobile terminals such as MBMS charging, etc.

### TECHNICAL FIELD

The technical field relates to multimedia broadcasting and/or multicasting in a wireless communications context.

### BACKGROUND AND SUMMARY

There is an ever increasing demand for wireless communication devices to perform a variety of applications. Current and future generations of mobile wireless communications devices, referred generally hereafter as mobile terminals, are striving to deliver multimedia services using one or both multicasting or broadcasting modes. Multicasting directs streaming media (audio, video, etc.) to plural specific subscribers. In contrast, broadcasting provides content that can be accessed by anyone with suitable equipment. Television and radio are examples of broadcasting, and a pay-per-view webcast is an example of multicasting.

A new service, called multimedia broadcast multicast service (MBMS), is being developed for both these modes of operation. MBMS will provide point-to-multi-point transmissions of multimedia data like text, audio, and video from a single point source over a radio interface to a broadcast area or to a multicast group. Although the content will typically be in a streaming format, e.g., MPEG/H.261 visual data and associated audio data, any content or format may be used. Similarly, the media can be delivered streamed, on-demand, or at a scheduled time.

The emphasis for current MBMS work is on radio interface efficiency. But this focus on the radio interface has ignored significant inefficiencies in the interface between the radio access network (RAN) and the core network. Consider, for example, providing a MBMS session in a GSM EDGE RAN (GERAN). The MBMS session content is provided as a data stream from the content provider to a gateway GPRS support node (GGSN) in the packet data core network. The GGSN delivers the data stream to each serving GPRS support node (SGSN) that has one or more mobile terminal MBMS subscribers having an “activated MBMS context” in the SGSN's geographic coverage area. Sending the MBMS data stream to each such SGSN creates a pool of SGSNs for that MBMS session. A base station controller (BSC) may well supervise the cell areas in which mobile terminals from multiple SGSNs in the MBMS session pool are located.

Unfortunately, in this situation, each SGSN in the MBMS session pool is not aware that its MBMS mobile terminals are being supervised in the GERAN by the same base station controller. As a result, each SGSN in the MBMS session pool will deliver to the base station controller the same MBMS session data stream for delivery to each SGSN's mobile terminals having an activated MBMS context. But the base station controller only needs to receive one MBMS session data stream from one SGSN. The remaining MBMS session data streams from the other SGSN's are unnecessary. What is needed is a mechanism to overcome this unnecessary data transfer between the pool of SGSNs and the base station controller. Nevertheless, it would be desirable to keep all of the SGSNs in the pool monitoring the MBMS session so that those SGSNs continue to perform traditional SGSN support functions such as charging for the MBMS services provided to MBMS subscribers.

The technology described herein meets these and other needs. A multimedia broadcast multicast type service (MBMS) is offered to mobile subscribers. A RAN node communicates with one or more radio base stations that transmit and receive information with mobile subscriber terminals, some of which subscribe to the MBMS. The RAN node communicates with multiple core network packet data nodes that receive MBMS data for delivery to the RAN node. Only one of the multiple core network packet data nodes is selected to provide the MBMS data associated with the MBMS to the RAN node. The other core network packet data nodes are instructed not to transfer the MBMS data. Nevertheless, those other core network packet data nodes are instructed to perform an MBMS function for mobile subscriber terminals receiving the MBMS data provided by the selected core network packet data node. For example, the MBMS function may be an MBMS charging or accounting function for mobile subscriber terminals receiving the MBMS data.

In one non-limiting example, an MBMS session start request message is received by the RAN node from each of multiple core network packet data nodes. The RAN node then replies to the selected core network packet data node with an MBMS session start response message that indicates that the selected core network packet data node should start transferring the MBMS data. It also replies to the other core network packet data nodes with an MBMS session start response message that indicates that the MBMS data should not be transferred but that the MBMS session is continuing. The core network packet data nodes may be Serving GPRS Support Nodes (SGSNs).

The RAN node may receive an MBMS session stop request message indicating that the selected SGSN has terminated the MBMS session. In that case, a consecutive MBMS session start response message is sent to one of the other multiple SGSNs, which previously requested MBMS session start, to start transferring the MBMS data. The MBMS session stop request message preferably includes an indication of why the selected SGSN sent the MBMS session stop request message. For example, if the session stop is because the content provider is terminating the MBMS session, then the RAN node knows not to order data transfer from another SGSN.

This technology may be implemented in a variety of different networks. For example, the RAN may be a GSM EDGE RAN (GERAN) and the RAN node a base station controller (BSC). The RAN may be a UMTS Terrestrial RAN (UTRAN) and the RAN node a radio network controller (RNC). The RAN may be a generic access network (GAN) and the RAN node a generic access network controller (GANC).

### BRIEF DESCRIPTION OF THE DRAWINGS

FIG. 1 is a function block diagram showing an example wireless communication system in which the MBMS technology may be used;

FIG. 2 illustrates the phases of MBMS multicast service provision;

FIG. 3 is a timeline illustrating the phases shown in FIG. 2;

FIG. 4 illustrates the phases of MBMS broadcast service provision;

FIG. 5 is timeline illustrating the phases shown in FIG. 4;

FIG. 6 is a function block diagram used to illustrate an example situation in which MBMS resources may be used more efficiently; and

FIGS. 7-13 are non-limiting example signaling diagrams that may be used in implementing an MBMS service.

### DETAILED DESCRIPTION

In the following description, for purposes of explanation and non-limitation, specific details are set forth, such as particular nodes, functional entities, techniques, protocols, standards, etc. in order to provide an understanding of the described technology. For example, one advantageous application is to multimedia communications in accordance with 3^{rd} Generation Project Partnership (3GPP) specifications. But other applications and other standards may be employed. It will be apparent to one skilled in the art that other embodiments may be practiced apart from the specific details disclosed below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs).

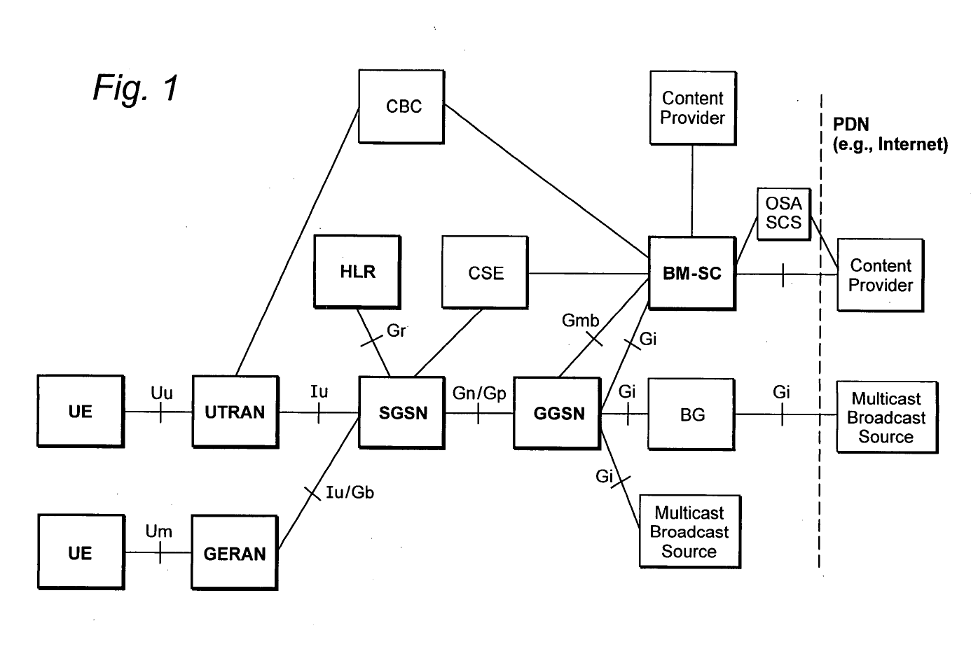

FIG. 1 illustrates an example system that supports wireless communications and MBMS services. This system may accommodate one or more standard architectures including a universal mobile telecommunications system (UMTS) (as well as other systems) based on code division multiple access (CDMA), GPRS/EDGE and other systems based on time division multiple access (TDMA), etc. In CDMA, different wireless channels are distinguished using different channelization codes or sequences, (these distinct codes are used to encode different information streams), which may then be modulated at one or more different carrier frequencies for simultaneous transmission. A receiver may recover a particular stream or flow for the receive signal using the appropriate code or sequence to decode the received signal. In TDMA, the radio spectrum is divided into time slots. Each time slot allows only one user to transmit and/or receive. TDMA requires precise timing between the transmitter and the receiver so that each user may transmit its information during its allocated time slot.

Example radio access networks (RAN) that provide radio access services to/from wireless user equipment (UE) (the terms UE and mobile terminal are used interchangeably) over a wireless interface (e.g., Uu or Um) include a UMTS terrestrial radio access network (UTRAN) and a GPRS/EDGE radio access network (GERAN), both of which are used in third generation cellular systems. The RAN may also be a generic access network (GAN) and the RAN node a generic access network controller (GANC). A RAN includes one or more radio network controllers (RNCs), base station controllers (BSCs), or generic access network controllers (GANCs). Each controller is coupled to one or more radio base stations (RBSs), sometimes referred to as Node B's. Transport of information over the communications interface between the RBS/Node B and RNC/BSC/GANC interfaces is typically based on asynchronous transfer mode (ATM) or Internet Protocol (IP).

The UTRAN communicates with core network serving GPRS support nodes (SGSNs) over an Iu interface, and the GERAN communicates with core network serving GPRS support nodes (SGSNs) over an Gb (or optionally Iu) interface. An SGSN supports packet-based communications. The SGSN is coupled to a UE subscriber database call the home location register (HLR) over a Gr interface. A cell broadcast service (CBS), which is distinct from MBMS, allows for low bit-rate data to be transmitted to all subscribers in a set of given cells over a shared broadcast channel. The gateway GPRS support node (GGSN) communicates with one or more SGSNs over a Gn/Gp interface and with a broadcast multicast service center (BM-SC) over a Gmb/Gi interface. The multicast/broadcast content is provided by an MBMS content provider.

The BM-SC provides functions for MBMS user service provisioning and delivery such as serving as an entry point for content provider MBMS transmissions and authorizing and initiating MBMS Bearer Services within the PLMN. The BM-SC is a functional entity that exists for each MBMS User Service. The BM-SC generates charging records for content provider transmitted data, and provides the GGSN with transport associated parameters such as quality-of-service and one or more MBMS service areas.

Further, the BM-SC may schedule MBMS session transmissions and retransmissions, retrieve content from external sources and provide this content using MBMS bearer services. The BM-SC labels each MBMS session with an MBMS Session Identifier to allow the UE to distinguish the MBMS session retransmissions. Each transmission and subsequent retransmission of a specific MBMS session are identified by a common MBMS Session Identifier (e.g., 2-3 octets) passed at the application layer in the content, which may also be passed in a shortened form (i.e., the least significant octet) in a MBMS Session Start Request message to sent to the RNCs/BSCs/GANCs in the RANs.

The GGSN serves as an entry point for IP multicast traffic as MBMS data. Upon notification from the BM-SC, the GGSN requests establishment of a bearer plane for a broadcast or multicast MBMS transmission. Bearer plane establishment for multicast services is carried out towards each SGSN (usually there are multiple such SGSNs) that have requested to receive transmissions for the specific multicast MBMS bearer service. The GGSN receives IP multicast traffic (whether from BM-SC or other data sources) and routes the traffic to the proper GTP tunnels set-up as part of the MBMS bearer service.

The SGSN role within MBMS architecture is to perform MBMS bearer service control functions for each individual UE and to provide MBMS transmissions to UTRAN/GERAN/GAN. The SGSN supports intra-SGSN and inter-SGSN mobility procedures, which requires the SGSN to store a user-specific MBMS UE context for each activated multicast MBMS bearer service and to pass these user-specific MBMS UE contexts to the new SGSN during inter-SGSN mobility procedures. The SGSN must generate charging data per multicast MBMS bearer service for each user. Each SGSN initially tries to establish Iu/Gb and Gn bearers shared by many users on demand when data has to be transferred to the users. But as described below, the Iu and Gb bearer establishment is controlled by the RNC/BSC/ or GANC.

UTRAN/GERAN/GAN are responsible for efficiently delivering MBMS data to the designated MBMS service area. Efficient delivery of MBMS data in multicast mode means that the UTRAN/GERAN/GAN must intelligently coordinate the MBMS data streams from the SGSNs and appropriate radio bearer selection for the number of UEs within each cell being serviced. The UTRAN/GERAN/GAN receive MBMS data from the SGSNs over Iu/Gb bearers shared by many UEs. The UTRAN/GERAN/GAN supports intra-RNC/BSC/GANC and inter-RNC/BSC/GANC mobility of MBMS receivers to limit data loss. The UTRAN/GERAN/GAN may transmit MBMS user service announcements and paging information (non-MBMS specific), and support other services in parallel with MBMS. For example, depending on terminal capabilities, the user could originate or receive a call or send and receive messages while receiving MBMS video content.

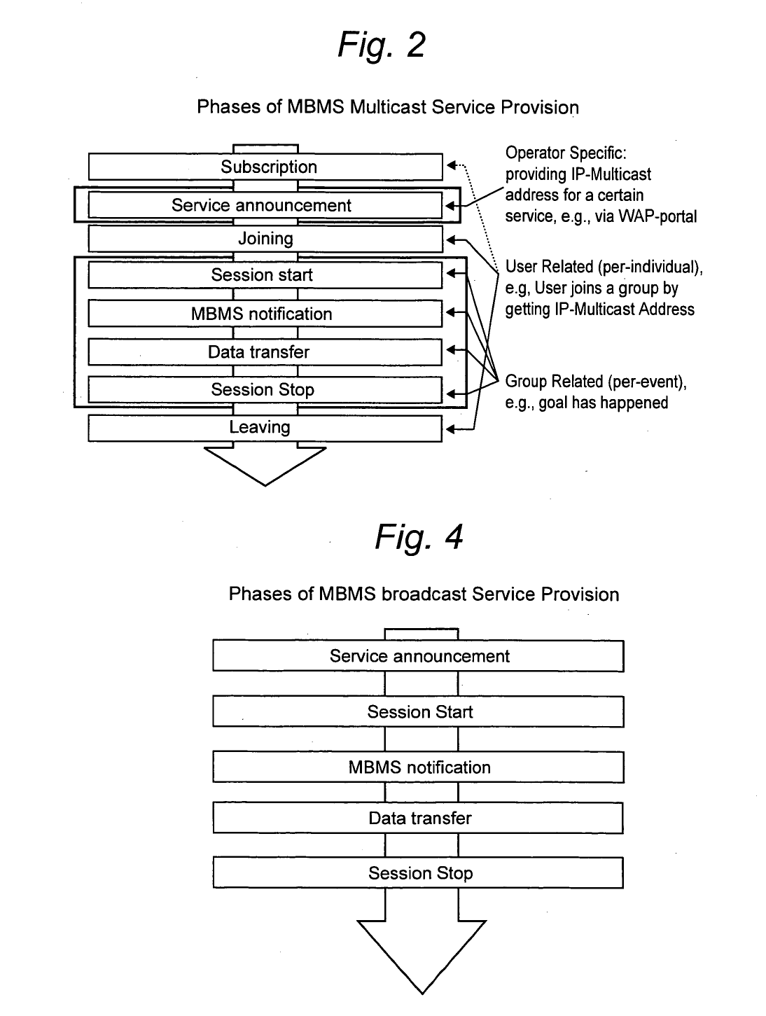

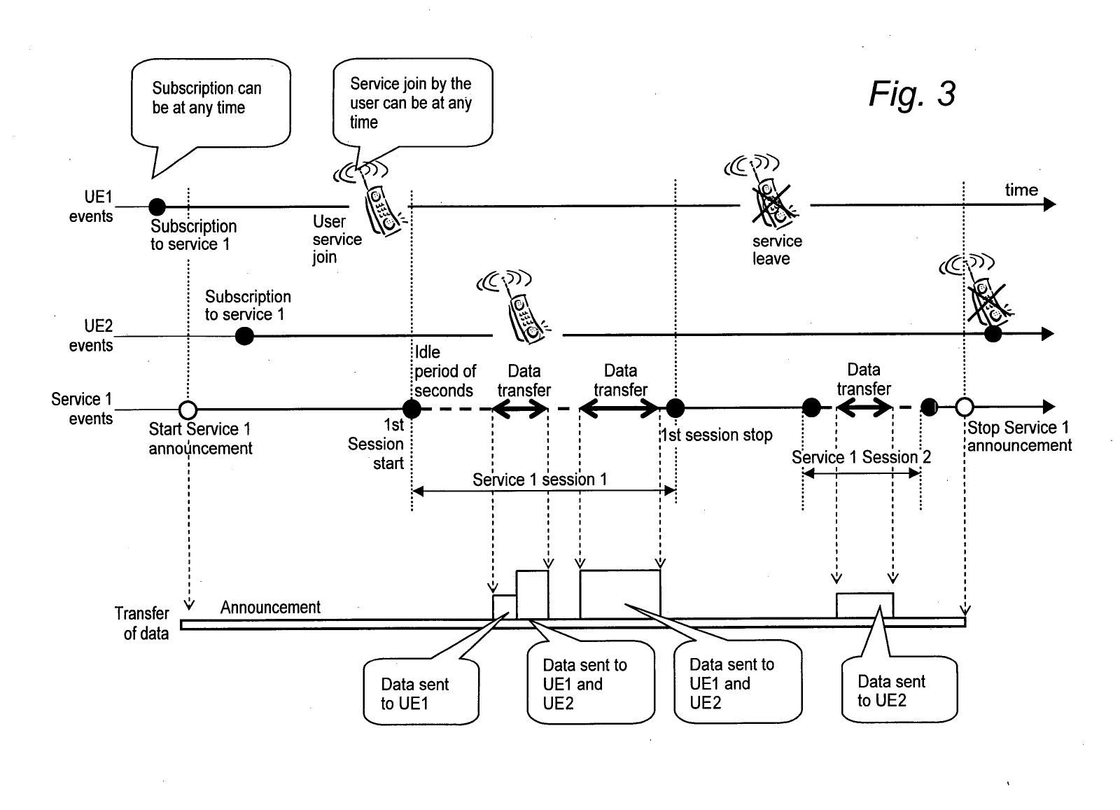

FIG. 2 illustrates phases of an MBMS multicast service. There are eight phases: subscription, service announcement, joining, session start, MBMS notification, data transfer, session stop, and leaving. The subscription, joining, and leaving phases are performed individually per user. The other phases are performed for all users interested in the related service. FIG. 3 illustrates these phases using a timeline example.

The subscription phase establishes the relationship between the user and the service provider, which allows the user to receive the related MBMS multicast service. A subscription is an agreement of a user to receive service(s) offered by an operator. Subscription information is recorded in the BM-SC. MBMS user service announcement/discovery mechanisms allow users to request or be informed about the range of MBMS user services available. A service announcement distributes to users information about the service, parameters required for service activation (e.g. IP multicast address), and possibly other service-related parameters (e.g. service start time). Joining (i.e., MBMS multicast activation by the user) is the process by which a subscriber joins (becomes a member of) a multicast group, i.e., the user indicates to the network that he/she is willing to receive multicast mode data of a specific MBMS bearer service. Session start is the point at which the BM-SC is ready to send data and occurs independently of activation of the service by the user. Session start also triggers bearer resource establishment for MBMS data transfer. MBMS notification informs the UEs about forthcoming (and potentially about ongoing) MBMS multicast data transfer, and data transfer is the phase when MBMS data are transferred to the UEs. Session stop is the point at which the BM-SC determines that there will be no more data to send for some period of time. This period is preferably long enough to justify removal of bearer resources associated with the session. At the leaving phase, a subscriber leaves (stops being a member of) a multicast group.

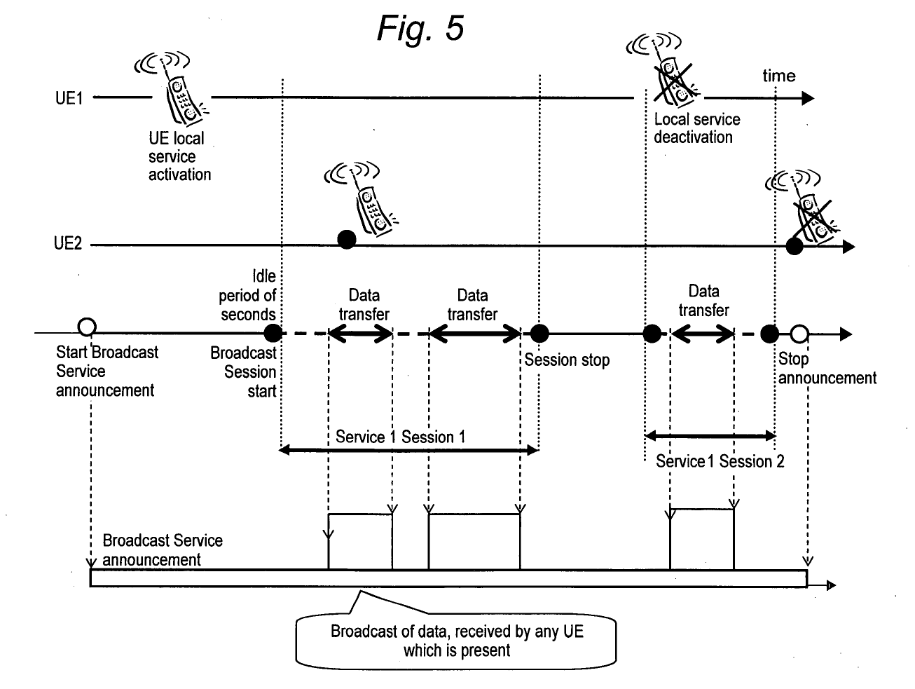

FIG. 4 illustrates phases of an MBMS broadcast service. There are five phases: service announcement, session start, MBMS notification, data transfer, and session stop. These phases have already been described above. FIG. 5 illustrates these phases using a timeline example.

An MBMS UE Context is created in the UE, RNC, SGSN, GGSN, and BM-SC when the UE joins an MBMS bearer service. The MBMS UE Context contains UE-specific information related to the particular MBMS bearer service that the UE has joined. In the SGSN, an MBMS UE Context is also created as a result of an inter-SGSN routing area update after the transfer of the MBMS UE Context from the old SGSN. There is one MBMS UE Context per MBMS bearer service that the UE has joined. Each MBMS UE Context may include, for example, an IP multicast address identifying an MBMS bearer that the UE has joined, a Temporary Mobile Group Identity (TMGI) allocated to the MBMS bearer, and an IMSI identifying the user.

An MBMS Bearer Context is created in each node involved in the delivery of the MBMS data and contains information describing a particular MBMS bearer service. An MBMS Bearer Context is created in the SGSN and GGSN when the first MBMS UE Context is created in the node or when a downstream node requests it. The MBMS Bearer Context may be created in an RNC when a first MBMS UE Context is created in the RNC. A Session Start procedure may create a MBMS Bearer Context in a BSC/RNC/GANC which has no MBMS Bearer Context yet. The MBMS Bearer Context may include the following: IP multicast address identifying the MBMS bearer described by this MBMS Bearer Context, Temporary Mobile Group Identity allocated to the MBMS bearer service, state of bearer plane resources (‘standby’ or ‘active’), area over which the MBMS bearer service has to be distributed, list of downstream nodes that have requested the MBMS bearer service and to which notifications and MBMS data have to be forwarded, number of UEs hosted by the node that have joined the multicast MBMS bearer service, and list of RAs, each of which contains at least one UE that has joined the MBMS service.

In this context, an inefficiency arises when multiple UEs being served by one RNC/BSC/GANC in the radio access network are serviced by different SGSNs. The SGSNs do not know this fact, which means that all of those SGSNs will naturally send the MBMS data for the same MBMS session received from the GGSN to the one RNC/BSC/GANC. In the UTRAN case, the RNC may establish an Iu bearer towards only one of the SGSNs at MBMS Session Start. But that would mean that the SGSNs that sent an MBMS session start request to the RNC, but to which no MBMS Iu bearer was established, could not correctly perform their MBMS-related functions such as MBMS session accounting and charging functions and others.

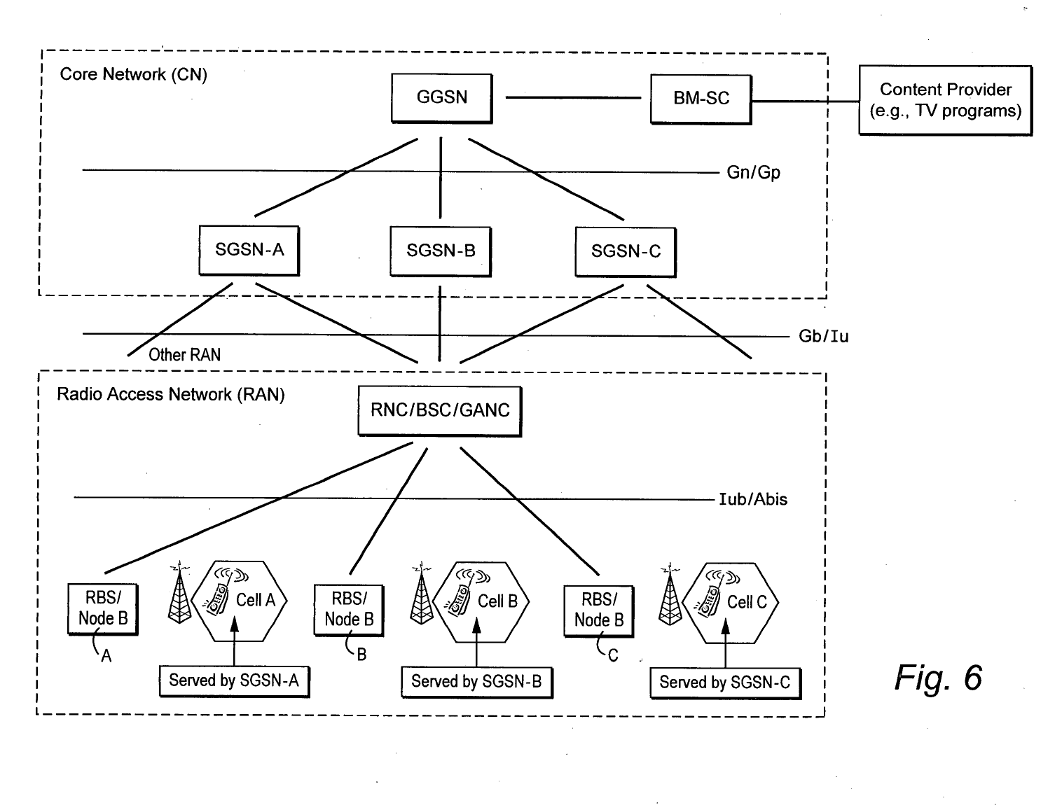

The problem is illustrated in FIG. 6 which shows three SGSNs A, B, and C coupled to one RNC/BSC/GANC, which in turn is coupled to three RBSs/Node B's A, B, and C having coverage areas including UEs served by the three different SGSNs A, B, and C, respectively. Rather than the RNC/BSC/GANC receiving three times the same information and wasting significant bandwidth and other resources in the process, the RNC/BSC/GANC selects one of the SGSNs A, B, or C to provide the MBMS session data traffic. The RNC/BSC/GANC informs the other two SGSNs not to send the MBMS session data traffic. Preferrably, the other two SGSNs remain engaged in the MBMS session to perform other MBMS session functions such as MBMS session accounting and charging functions and others.

The following implementation example describes specific signaling messages exchanged between a BSC and the three SGSNs A, B, and C in a GERAN. Of course, other messages and other RAN nodes may be used. The basic signaling messages are adapted from those specified in 3GPP TS 23.246 V.6.4.0. Again, other signaling messages may be employed which may or may not be consistent with 3GPP TS 23.246 V.6.4.0 or other specifications.

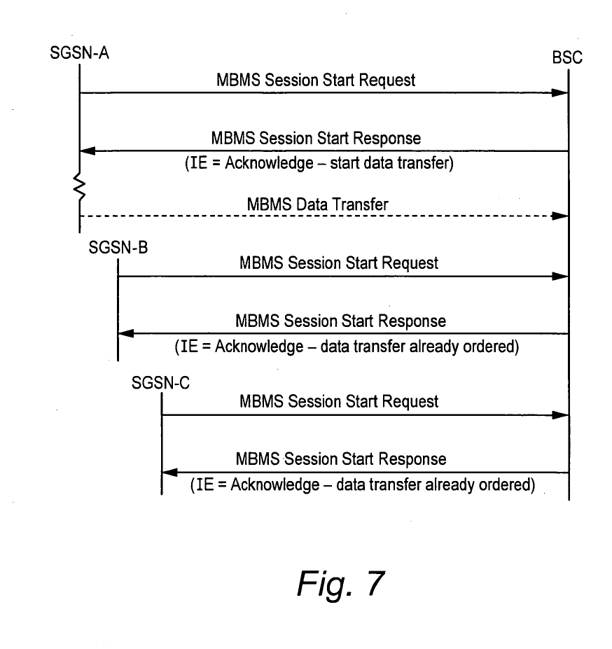

Referring to FIG. 7, the BSC first receives an MBMS SESSION START REQUEST message from connected SGSN-A. The MBMS Bearer Context for this MBMS session is created, and the relevant information is stored the BSC. The BSC then initiates allocation of radio resources in the MBMS Service Area for delivery of the MBMS data traffic over the Um interface to UEs in its service areas: cells A, B, and C. The BSC sends an MBMS SESSION START RESPONSE message including an “MBMS Response” information element (IE) set to indicate “Acknowledge—start data transfer.” The identity of the SGSN-A is stored in the MBMS Bearer Context to indicate that SGSN-A has ordered an MBMS Session Start. The BSC receives consecutive MBMS SESSION START REQUEST messages from SGSN-B and SGSN-C. The BSC replies with an MBMS SESSION START RESPONSE message including an “MBMS Response” information element set to indicate “Acknowledge—data transfer already ordered.” In this way, the BSC informs the non-selected SGSNs not to send the MBMS session data.

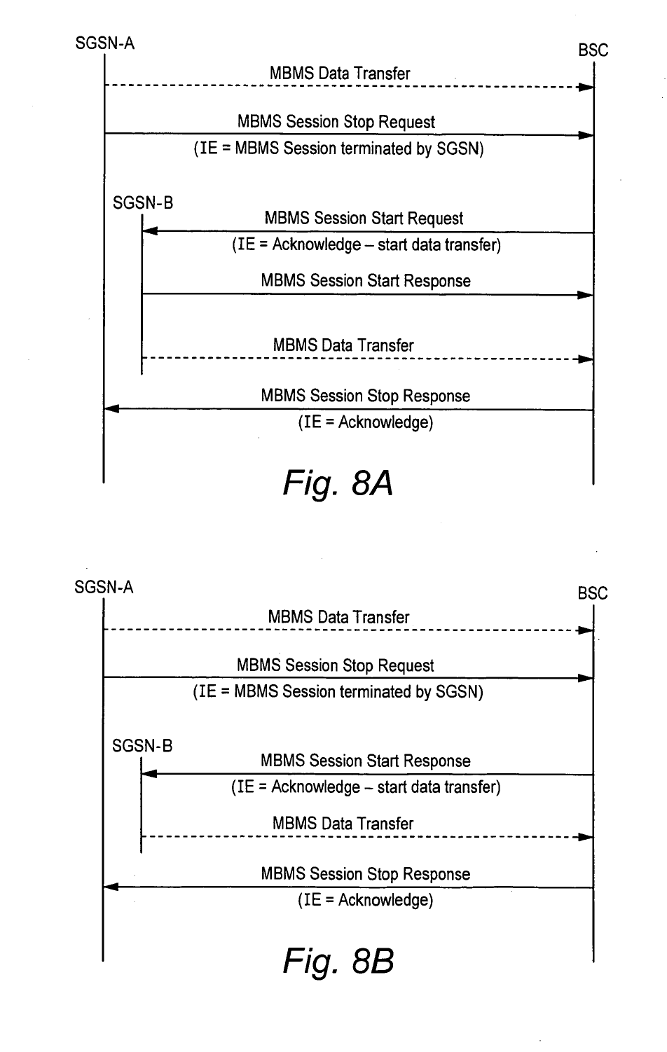

FIG. 8 illustrates a situation where the selected SGSN-A terminates the MBMS session. The BSC receives an MBMS SESSION STOP REQUEST message containing an “MBMS Stop Cause” IE set to “MBMS Session terminated by SGSN” from the SGSN performing the data transfer (SGSN-A). Another SGSN stored in the MBMS Bearer Context is chosen (SGSN-B), and a consecutive MBMS SESSION START REQUEST message including the “MBMS Response” IE set to “Acknowledge—start data transfer” is sent to the chosen SGSN-B. SGSN-A is removed from the MBMS Bearer Context. An MBMS SESSION START RESPONSE message is sent from the SGSN-B to the BSC, and the SGSN-B starts transferring the MBMS session data to the BSC. An MBMS SESSION STOP RESPONSE message including the “MBMS Response” IE set to “Acknowledge” is sent to the SGSN-A that initiated the MBMS SESSION STOP REQUEST.

Alternatively, the BSC may send a MBMS SESSION START RESPONSE MESSAGE including the “MBMS Response” IE set to “Acknowledge—start data transfer” to the SGSN-B, and the SGSN-B starts transferring the MBMS session data to the BSC. An MBMS SESSION STOP RESPONSE message including the “MBMS Response” IE set to “Acknowledge” is then also sent to the SGSN-A that initiated the MBMS SESSION STOP REQUEST.

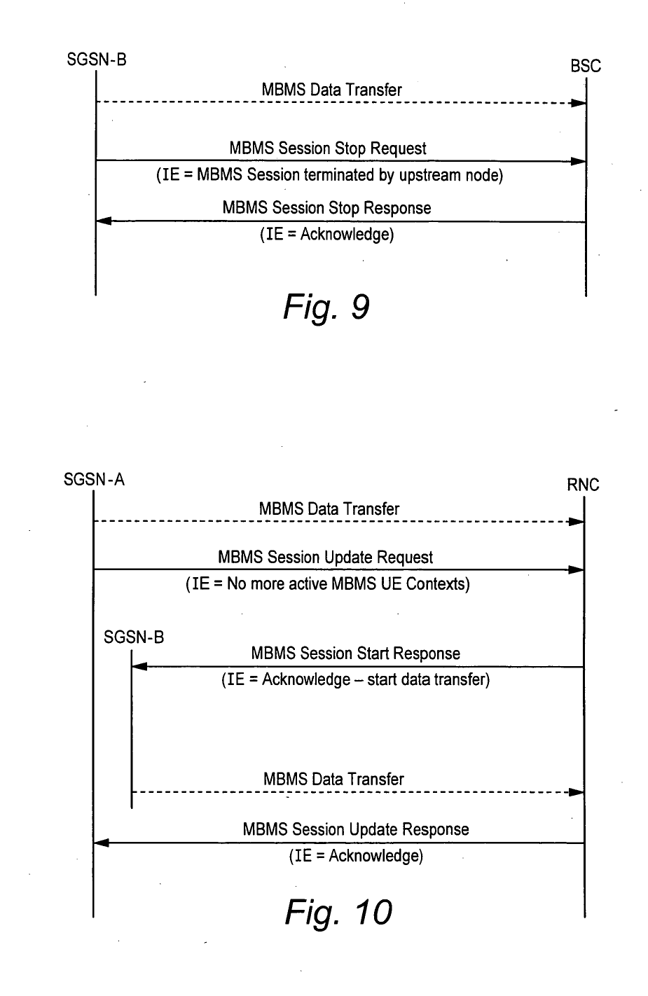

FIG. 9 shows signaling when the MBMS session is stopped by an upstream node. The BSC receives an MBMS SESSION STOP REQUEST message with an “MBMS Stop Cause” IE set to “MBMS Session terminated by upstream node” from the SGSN currently performing the data transfer (SGSN-B). The BSC may also receive similar messages from other active SGSNs, e.g., SGSN-C. But preferably the message is only received by currently performing the data transfer (SGSN-B). All SGSN identities are removed from the MBMS Bearer Context. The MBMS Bearer Context is deleted, and all radio resources associated with the MBMS session are released. An MBMS SESSION STOP RESPONSE message including the “MBMS Response” IE set to “Acknowledge” is sent to the SGSN-B that initiated the MBMS SESSION STOP REQUEST message.

FIGS. 10-13 offer alternative, non-limiting, examples. In FIG. 10, the BSC receives an MBMS SESSION UPDATE REQUEST message containing an “MBMS Update Cause” IE set to “No more active MBMS UE Contexts” from the SGSN performing the data transfer (SGSN-A). Another SGSN stored in the MBMS Bearer Context is chosen (SGSN-B) and a second MBMS SESSION START RESPONSE message including the “MBMS Response” IE set to “Acknowledge—start data transfer” is sent to the chosen SGSN-B. The SGSN-A identity is removed from the MBMS Bearer Context in the BSC. An MBMS SESSION UPDATE RESPONSE message including the “MBMS Response” IE set to “Acknowledge” is sent to the SGSN-A that initiated the MBMS SESSION UPDATE REQUEST message.

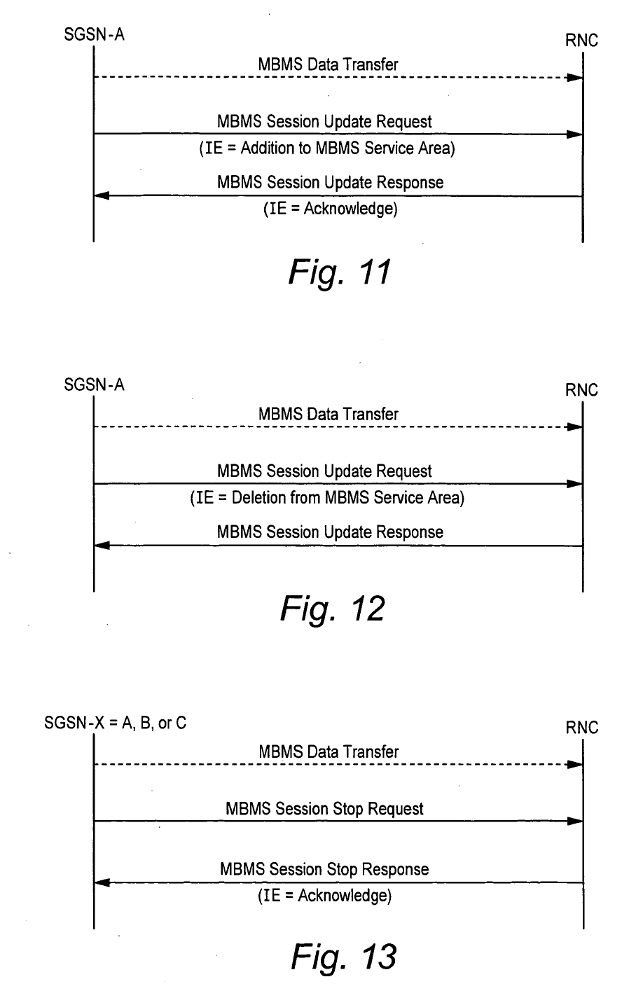

In FIG. 11, the BSC receives an MBMS SESSION UPDATE REQUEST message with the “MBMS Update Cause” IE set to “Addition to MBMS Service Area” from the SGSN performing the data transfer (SGSN-A). The MBMS Bearer Context is updated in the BSC with the relevant MBMS Service Area information. Radio resources are allocated in the new cell(s) indicated by the updated MBMS Service Area sent by the SGSN-A. An MBMS SESSION UPDATE RESPONSE message including an “MBMS Response” IE set to “Acknowledge” is sent to the SGSN-A that initiated the MBMS SESSION UPDATE REQUEST message.

In FIG. 12, the BSC receives an MBMS SESSION UPDATE REQUEST message containing an “MBMS Update Cause” IE set to “Deletion from MBMS Service Area” from the SGSN performing the data transfer (SGSN-A). The MBMS Bearer Context in the BSC is updated with the relevant MBMS Service Area information. Radio resources are released in the cell(s) indicated by the updated MBMS Service Area sent by the SGSN-A. An MBMS SESSION UPDATE RESPONSE message including the “MBMS Response” IE set to “Acknowledge” is sent to the SGSN-A that initiated the MBMS SESSION UPDATE REQUEST.

In FIG. 13, the BSC receives an MBMS SESSION STOP REQUEST message from any of the SGSNs stored in the MBMS Bearer Context. All SGSN identities are removed from the MBMS Bearer Context stored in the BSC. The MBMS Bearer Context is deleted, and all radio resources associated with the MBMS Session are released. An MBMS SESSION STOP RESPONSE message including the “MBMS Response” IE set to “Acknowledge” is sent to the SGSN that initiated the MBMS SESSION STOP REQUEST.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 USC §112 unless the words “means for” are used.

1. A radio access network (RAN) node for use in a system that provides a multimedia broadcast multicast type service (MBMS) to mobile subscribers, comprising:
first interface circuitry for communicating with one or more radio base stations that transmit and receive information with mobile subscriber terminals some of which subscribe to the MBMS;
second interface circuitry for communicating with multiple core network packet data nodes that receive MBMS data for delivery to the RAN node; and
processing circuitry configured to select one of the multiple core network packet data nodes to provide the MBMS data associated with the MBMS to the RAN node and to indicate to one or more of the other multiple core network packet data nodes not to provide the MBMS data.

2. The RAN node in claim 1, wherein the processing circuitry is configured to reserve RAN resources in order to provide the MBMS data to the mobile subscriber terminals requesting the MBMS.

3. The RAN node in claim 1, wherein the processing circuitry is configured to indicate to one or more of the other multiple core network packet data nodes to perform an MBMS function for mobile subscriber terminals receiving the MBMS data provided by the selected core network packet data node.

4. The RAN node in claim 3, wherein the MBMS function is an MBMS charging or accounting function for mobile subscriber terminals receiving the MBMS data.

5. The RAN node in claim 1, wherein the core network packet data nodes are serving GPRS support nodes (SGSNs), and wherein the processing circuitry is configured:
to receive a MBMS session start request message from each of multiple core network packet data nodes,
to reply to the selected core network packet data node with an MBMS session start response message that indicates that the selected core network packet data node should start transferring the MBMS data, and
to reply to the other core network packet data nodes with an MBMS session start response message that indicates that the MBMS data not be transferred.

6. The RAN node in claim 5, wherein the processing circuitry is configured to receive an MBMS session stop request message indicating that the selected SGSN has terminated the MBMS session, and
wherein in response, the processing circuitry is configured to send an MBMS session start request message to another of the multiple SGSNs to start transferring the MBMS data.

7. A communications system using the RAN node of claim 6, wherein the MBMS session stop request message includes an indication of why the selected SGSN sent the MBMS session stop request message.

8. The RAN node in claim 5, wherein the processing circuitry is configured to receive an MBMS session stop request message indicating that the selected SGSN has terminated the MBMS session, and
wherein in response, the processing circuitry is configured to send an MBMS session start response message to another of the multiple SGSNs to start transferring the MBMS data.

9. A communications system using the RAN node of claim 8, wherein the MBMS session stop request message includes an indication of why the selected SGSN sent the MBMS session stop request message.

10. The RAN node in claim 5, wherein the RAN is a GSM EDGE RAN (GERAN) and the RAN node is a base station controller (BSC).

11. The RAN node in claim 5, wherein the RAN is a UMTS Terrestrial RAN (UTRAN) and the RAN node is a radio network controller (RNC).

12. The RAN node in claim 5, wherein the RAN is a generic access network (GAN) and the RAN node is a generic access network controller (GANC).

13. A communications system using the RAN node of claim 1.

14. A method for use in a system that provides a multimedia broadcast multicast type service (MBMS) to mobile subscribers, comprising:
receiving a message from multiple core network packet data nodes to start delivery of MBMS data;
selecting one of the multiple core network packet data nodes to provide the MBMS data associated with the MBMS; and
instructing one or more of the other multiple core network packet data nodes to not provide the MBMS data.

15. The method in claim 14, further comprising:
reserving RAN resources in order to provide the MBMS data to the mobile subscriber terminals requesting the MBMS.

16. The method in claim 14, further comprising:
indicating to one or more of the other multiple core network packet data nodes to perform an MBMS function for mobile subscriber terminals receiving the MBMS data provided by the selected core network packet data node.

17. The method in claim 16, wherein the MBMS function is an MBMS charging or accounting function for mobile subscriber terminals receiving the MBMS data.

18. The method in claim 14, wherein the core network packet data nodes are serving GPRS support nodes (SGSNs), the method further comprising:
receiving a MBMS session start request message from each of multiple core network packet data nodes,
replying to the selected core network packet data node with an MBMS session start response message that indicates that the selected core network packet data node should start transferring the MBMS data, and
replying to the other core network packet data nodes with an MBMS session start response message that indicates that the MBMS data not be transferred.

19. The method in claim 18, further comprising:
receiving an MBMS session stop request message indicating that the selected SGSN has terminated the MBMS session, and
sending an MBMS session start request message to another of the multiple SGSNs to start transferring the MBMS data.

20. The method in claim 19, wherein the MBMS session stop request message includes an indication of why the selected SGSN sent the MBMS session stop request message.

21. The method in claim 18, further comprising:
receiving an MBMS session stop request message indicating that the selected SGSN has terminated the MBMS session, and
sending an MBMS session start response message to another of the multiple SGSNs to start transferring the MBMS data.

22. The method in claim 21, wherein the MBMS session stop request message includes an indication of why the selected SGSN sent the MBMS session stop request message.
